(19) United States
(12) Patent Application Publication
(10) Pub. No.: US 2005/0286751 A1
(43) Pub. Date: Dec. 29, 2005

(54) Apparatus for discriminating paper-like sheets and method for discriminating same

(75) Inventor: Yoichi Mizoi, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Sanyo Electric Co., Ltd., Osaka-Fu (JP)

(21) Appl. No.: 11/108,857

(22) Filed: Apr. 19, 2005

(30) Foreign Application Priority Data
Jun. 29, 2004 (JP) 2004-190797

(51) Int. Cl. G06K 9/00

(52) U.S. Cl. 382/135

(57) ABSTRACT

A method for discriminating paper-like sheets comprises an authenticity judgment step. The authenticity judgment step includes a pattern detection step for irradiating infrared light on predetermined irradiation lines X in a direction along which the paper-like sheet M is to be inserted with a predetermined interval to detect a pattern of amounts of transmitted light on the predetermined irradiation lines X; an arithmetic processing step for comparing the pattern of amounts of transmitted light obtained by the pattern detection step with a pattern of amounts of transmitted light which has been previously obtained from a genuine paper-like sheet MA by means of the pattern detection step to standardize data, thereby obtaining standard values S at the respective irradiation points P of the paper-like sheet M inserted; and a judgment step for comparing the standard values S with the maximum standard value Tₘₐₓ of the genuine paper-like sheet MA which has been previously obtained, thereby to judge the paper-like sheet M as a counterfeit note when the number of the standard values S each of which is larger than the maximum standard value Tₘₐₓ reaches a predetermined number.

The present application is based on Japanese patent application No. 2004-190797, the entire contents of which are incorporated herein by reference.

### BACKGROUND OF THE INVENTION

1. Field of the Invention

The present invention relates to an apparatus for discriminating paper-like sheets and a method for discriminating the same, and particularly to an apparatus for discriminating paper-like sheets and a method for discriminating the same by which a definite judgment of authenticity can be made on a paper money without being adversely affected by a condition of the paper money after circulation.

2. Description of the Related Art

Heretofore, a principal part of a paper-like sheet discrimination apparatus used for paper-like sheets inserted such as paper moneys inserted is usually composed of an insertion detection part, a convey part, and an authenticity judgment part wherein judgment of authenticity in an inserted paper-like sheets is carried out by extracting magnetically or optically characteristic features of the inserted paper-like sheet in question by the use of a magnetic sensor or an optical sensor in the authenticity judgment part.

In these apparatuses, determination of authenticity in a paper-like sheet by means of a transmission type sensor is performed in such that a light emitting device is disposed opposedly to a light receiving device with a predetermined spacing so as to form a passageway therebetween, a paper-like sheet is conveyed through the passageway to extract a light and shade pattern of transmitted light, and the resulting pattern is compared with a standard light and shade pattern of a genuine note which has been previously stored and maintained. In this respect, however, there are various grades of paper extending over a range from a brand-new one which is just issued to an old one which is stained and damaged during a course of circulation. Hence, there are remarkable dispersions in optical, magnetic or the like characteristic features being factors for discriminating such papers, even if papers to be discriminated with respect to authenticity belong to the same type, so that it was very difficult to judge such authenticity.

In order to solve such problem as described above, there is an approach for judging authenticity in such that a paper money discriminator is provided with a means for scanning a paper money by a relative movement with the paper money, and irradiating lights on the paper money to detect a pattern of amounts of transmitted light through the paper money; and a means for evaluating an amount of transmitted light which is extracted from a watermark design area in the paper money by the above-described pattern detection means with the use of the maximum value of a pattern of amounts of transmitted lights detected from a usual design area other than the watermark design, and judging the watermark design of the paper money on the basis of the evaluated value. More specifically, this approach utilizes optical characteristic features of a paper money and pays attention to an overall stain of the paper money after circulation, whereby data of the maximum transmission level among amounts of transmitted light which are obtained by scanning usual design areas (an area containing no watermark) in the paper money is made to be a standard transmission level in a usual design area, and the standard transmission level is used to relativize with the maximum transmission level in watermark areas, so that an existence of a watermark area is judged to determine authenticity of the paper money (see Japanese patent application laid-open No. 2003-187291).

Furthermore, as another approach as to a paper money discriminator, there is an apparatus which can discriminate a changeover in old and new paper moneys wherein an altered (new) paper money prepared by setting newly a given seal on a design which has already been printed on an old paper money. This approach is similar to the former approach in that optical characteristic features of a paper money are utilized in such that discrimination information is obtained by a sensor from design areas and the like on the paper money in the form of an output waveform (see Japanese patent application laid-open No. 2003-187294).

According to the former approach, however, since a boundary between a usual design area and a watermark area is very indefinite, it is unclear whether the maximum transmission level of usual design areas belongs to the usual design area or not, but the watermark area. Accordingly, a standard transmission level itself becomes unstable. Even if the standard transmission level can be determined, there is a case where all over the paper money must be scanned by a sensor in order to determine such target site, resulting in a problem wherein processing cannot be completed for a short period of time.

On the other hand, concerning the latter approach, there is a problem in that it is not practical. This is because discrimination can also be achieved without using any discriminator in the latter case. This is because a seal to be newly set on an old paper money is made manually by an operator, so that when a newly altered paper money is observed in respect of a whole design including such seal and the like, dispersions appear inevitably among newly altered paper moneys or between old and new paper moneys, and hence, discrimination can be achieved by visual check based on such dispersions.

Moreover, beyond expectation of these two approaches, there is a case where dispersions appear among genuine notes due to out of alignment in printing and the like according to various conditions at the time of printing paper moneys, even if they are very slight. Thus, there is such a fear that counterfeit which comes to be in ingenious and skill in recent years gets hold of such dispersions.

Accordingly, an object of the present invention is to eliminate such problems as described above as much as possible and to provide particularly an apparatus for discriminating paper-like sheets and a method for discriminating the same by which authenticity can be more precisely judged with respect to counterfeit paper moneys and the like which cause recently social problems, and specifically to provide an apparatus for discriminating paper-like sheets having the most remarkable characteristic in its authenticity judgment part and a method for discriminating the same.

### SUMMARY OF THE INVENTION

In order to achieve the above-described object, a method for discriminating paper-like sheets according to the present invention comprises an authenticity judgment step; the authenticity judgment step including a pattern detection step for irradiating infrared light on predetermined irradiation lines extending in a paper-like sheet along the direction corresponding to that to be inserted with a predetermined interval to detect amounts of a pattern of transmitted light on the predetermined irradiation lines; an arithmetic processing step for comparing amounts of the pattern of transmitted light through the paper-like sheet obtained by the pattern detection step with amounts of a pattern of transmitted light through a genuine paper-like sheet which has been previously obtained by means of the pattern detection step to standardize data thereby obtaining standard values at the respective irradiation points of the paper-like sheet inserted; and a judgment step for comparing the standard values with the maximum standard value of the genuine paper-like sheet which has been previously obtained thereby to judge the paper-like sheet as a counterfeit note in the case when the number of the standard values each of which is larger than the maximum standard value reaches a predetermined number.

Therefore, according to the discrimination method of the present invention, the authenticity judgment part is constituted based on algorithm in accordance with statistical technique, so that it is highly reliable and precise authenticity judgment can be achieved.

In the method for discriminating paper-like sheets according to the invention, the paper-like sheet inserted and the genuine paper-like sheet are the same kinds of paper moneys wherein watermark areas and the other design areas are arranged.

Thus, in the same kind of paper moneys containing watermark areas and the other design areas, for example, one thousand-yen notes, five thousand-yen notes, and ten thousand-yen notes, such two typical characteristics can be utilized for authenticity judgment to the fullest extent, whereby reliability in the authenticity judgment can be more elevated.

In the method for discriminating paper-like sheets according to the invention, the genuine paper-like sheet is two or more pieces.

This is because there is such a reason that mutual dispersions in physical properties of genuine paper-like sheets are optically detected to obtain pertinent standard data.

In the method for discriminating paper-like sheets according to the invention, the standard values are calculated through a division of differences between an average value of amounts of transmitted lights at the respective irradiation points on the predetermined irradiation lines in a genuine paper-like sheet which have been previously obtained and amounts of transmitted light at irradiation points corresponding to respective irradiation points on the predetermined irradiation lines of the paper-like sheet inserted by standard deviations of the amounts of transmitted light at the respective irradiation points in the genuine paper-like sheet.

As a result, standardization for unifying data of the paper-like sheet inserted and the genuine paper-like sheet in their levels can be realized.

In the method for discriminating paper-like sheets according to the invention, the maximum standard value is the maximum numerical value among values calculated through a division of differences between an average value of amounts of transmitted lights on respective irradiation points on the predetermined irradiation lines in the genuine paper-like sheet which have been previously obtained and amounts of transmitted lights on respective irradiation points of respective genuine paper-like sheets by standard deviations of amounts of transmitted light at the respective irradiation points.

The maximum standard value thus determined is used for authenticity judgment as an evaluation reference value with respect to standard values at the respective irradiation points in the paper-like sheet inserted.

In the method for discriminating paper-like sheets according to the invention, the pattern detection step detects the pattern of amounts of transmitted light through the inserted paper-like sheet and the genuine paper-like sheet, each having watermark areas and the other design areas.

In the method for discriminating paper-like sheets according to the present invention, an instruction for adding the standard value calculated in a paper-like sheet inserted to a standard value at the following irradiation point is issued for a further comparison, when the standard value calculated is judged that it is larger than the maximum standard value in the genuine paper-like sheet.

Furthermore, an apparatus for discriminating paper-like sheets according to the present invention comprises an authenticity judgment part; the authenticity judgment part including a pattern detection means for irradiating infrared light on predetermined irradiation lines extending in a paper-like sheet along the direction corresponding to that to be inserted with a predetermined interval to detect amounts of a pattern of transmitted light on the predetermined irradiation lines; an arithmetic processing means for comparing amounts of the pattern of transmitted light through the paper-like sheet obtained by the pattern detection means with amounts of a pattern of transmitted light through a genuine paper-like sheet which has been previously obtained by means of the pattern detection means to standardize data thereby obtaining standard values at the respective irradiation points of the paper-like sheet inserted; and a judgment means for comparing the standard values with the maximum standard value of the genuine paper-like sheet which has been previously obtained thereby to judge the paper-like sheet as a counterfeit note in the case when the number of the standard values each of which is larger than the maximum standard value reaches a predetermined number.

Thus, because of standardization, the apparatus of the present invention is not adversely affected by a present state of a paper-like sheet inserted (in case of a paper money, for example, stains due to circulation, wetness, aged deterioration in printed areas and the like), but reliability in authenticity judgment with respect to a genuine paper-like sheet can be elevated.

In the apparatus for discriminating paper-like sheets according to the invention, the pattern detection means contains a plurality of light projection areas and a plurality of light reception areas arranged in parallel corresponding to a plurality of irradiation lines, respectively.

In the apparatus for discriminating paper-like sheets according to the invention, the pattern detection means irradiates infrared light based on a pattern of the irradiation points stored in a memory.

In the apparatus for discriminating paper-like sheets according to the invention, the authenticity judgment part is composed of the pattern detection means, arithmetic processing means, and the judgment means.

In the apparatus for discriminating paper-like sheets according to the invention, the discrimination sensor is a reflection type sensor in which infrared light is projected and received on the same side.

In the apparatus for discriminating paper-like sheets according to the invention, the discrimination sensor is constituted in such that infrared light is irradiated at a given input angle, and a light reception area is disposed through reflection.

According to the apparatus for discriminating a paper-like sheet of the present invention, when the number of sample in genuine paper-like sheets is increased, dispersions among samples can be processed statistically, so that reliability in a numerical value to be a criterion of genuine paper-like sheet can be elevated. Besides, since characteristic features of watermark areas and the other design areas are introduced, judgment functions for authenticity discrimination can be fulfilled. In addition, since standardization is introduced, judgment is not adversely affected by an existing state of an inserted paper-like sheet after circulation, whereby precise authenticity judgment can also be achieved.

On one hand, according to the method for discriminating a paper-like sheet of the present invention, since a simplified algorithm is introduced, the apparatus itself is not complicated, but authenticity judgment processing can be precisely and rapidly realized.

### BRIEF DESCRIPTION OF THE DRAWINGS

The present invention will be explained in more detail in conjunction with appended drawings, wherein:

FIG. 1A is a sectional view showing an apparatus for discriminating paper-like sheets according to the present invention;

FIG. 1B is a block diagram showing an authenticity judgment part of FIG. 1A;

FIG. 2 is a diagram showing an example of a paper money and irradiation lines disposed on the paper money;

FIG. 3 is a constitutional diagram showing a controller contained in the apparatus for discriminating a paper-like sheet of FIG. 1A; and

FIG. 4 is a flowchart showing processing steps of the authenticity judgment part of FIG. 1B.

### DESCRIPTION OF THE PREFERRED EMBODIMENTS

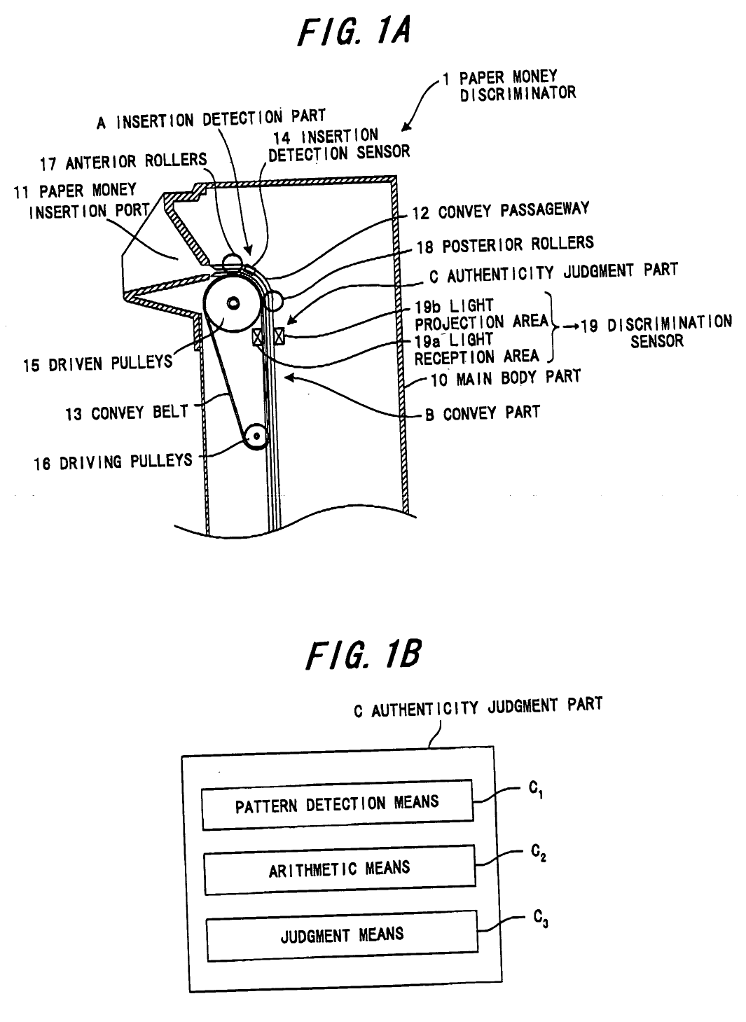

A preferred embodiment for executing an apparatus for discriminating a paper-like sheet and a method for discriminating a paper-like sheet according to the present invention will be described hereinafter by referring to FIGS. 1 to 3.

(Constitution of Apparatus 1 for Discriminating Paper-Like Sheets)

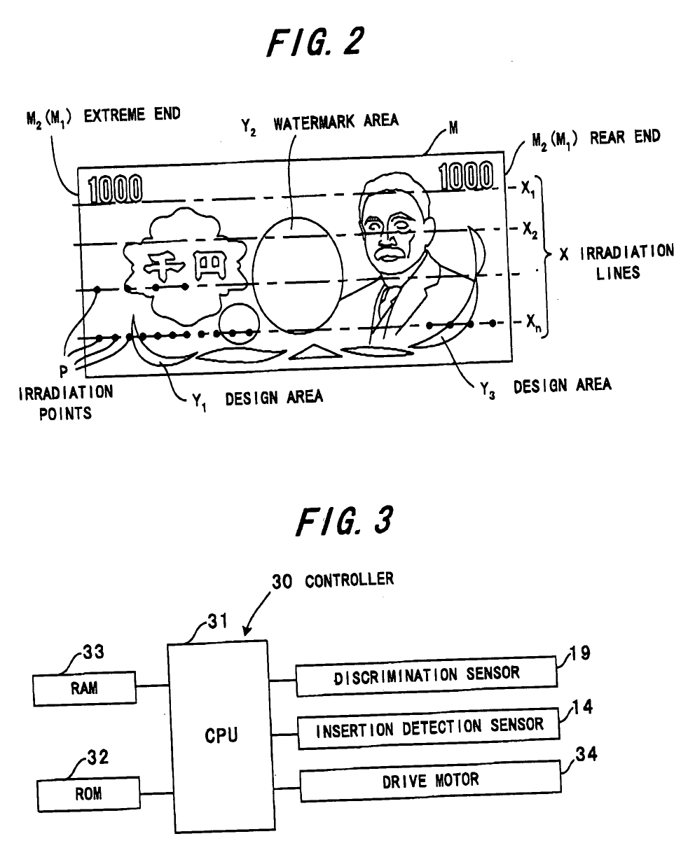

FIG. 1A is a sectional view showing the apparatus 1 for discriminating paper-like sheets (hereinafter optionally referred to as “paper-like sheet discriminator 1), and for convenience, the paper-like sheet discriminator 1 is considered to be a paper money discriminator in the following description. The paper money discriminator 1 includes a main body part 10 having a paper money container (not shown) for containing a paper money M shown in FIG. 2 therein and taking out properly the paper money M contained, and a paper money insertion port 11 for inserting the paper money M, the port being disposed at the front upper site of the main body part 10. The paper money discriminator 1 is constituted in such that the paper money M inserted from the paper money insertion port 11 is conveyed to determine authenticity of the paper money M, and either continues to convey the paper money M as it is, whereby the paper money M is contained in the container in the case where the paper money M is a genuine note, or the paper money M is reversely conveyed to be returned to the paper money insertion port 11 in the case where the paper money M is a counterfeit note.

An insertion detection part A is composed of an insertion detection sensor 14 and a central processing unit 31 (hereinafter referred to as “CPU”) which will be described later wherein the insertion detection sensor 14 detects insertion of the paper money M into a convey passageway 12 from the paper money insertion port 11 to output a detection signal to the CPU 31.

For the sake of guiding the paper money M inserted into the paper money insertion port 11 to the paper money container, a convey part B provides a convey passageway 12 having a substantially semicircular contour following to the paper money insertion port 11 in the main body part 10, whereby the paper money M is guided to the paper money container.

The convey part B includes further a pair of driven pulleys 15, 15 rotating around a revolving shaft as its center and disposed in the vicinities of the paper money insertion port 11 in the main body part 10; a pair of driving pulleys 16, 16 driven by a drive motor 34, when insertion of the paper money M is detected by the insertion detection sensor 14; a pair of convey belts 13, 13 stretched between the pair of the driven pulleys 15, 15 and the pair of the driving pulleys 16, 16, and rotated in accordance with driving of the pair of the driving pulleys 16, 16, whereby the paper money M in the convey passageway 12 is conveyed; and a pair of anterior rollers 17, 17 and a pair of posterior rollers 18, 18 which are urged elastically and rotatably upon surfaces of the convey belts 13, 13 positioned on the outer peripheries of the driven pulleys 15, 15 by means of springs and the like, so that these rollers cooperate with the convey belts 13, 13 to hold the paper money M.

An authenticity judgment part C is composed of a discrimination sensor 19 and the CPU 31 wherein the discrimination sensor 19 is constituted in such that a light projection area 19a is opposed to a light reception area 19b so as to face the convey passageway 12, respectively, at a position between the driven pulleys 15, 15 and the driving pulleys 16, 16, whereby predetermined irradiation lines X on the paper money M conveyed through the convey passageway 12 are scanned with a constant interval, so that amounts of a pattern of transmitted light (including individual data and the like) through the paper money M are obtained with the predetermined irradiation lines X to output the results to the CPU 31 as electrical signals.

FIG. 1B is a block diagram showing the authenticity judgment part C including a pattern detection means C₁, arithmetic processing means C₂, and a judgment means C₃ which may be included in a CPU 31 to be explained later.

In this case, the discrimination sensor 19 is essentially a transmission type infrared optical sensor and has a rotating structure such as a rotary encoder (not shown) with respect to the paper money M, and the discrimination sensor 19 emits pulsed light with a constant interval from the light projection area 19a. The pulsed light is projected on the irradiation lines X extending from an inserted extreme end M1 (M2) to a rear end M2 (M1) of the paper money M, and an amount of transmitted light at each position on the irradiation lines X is detected by the light reception area 19b (which becomes a pattern detection means). The amounts of transmitted light are converted to electrical signals to output them to the CPU 31. Of course, since pulsed light is projected on the irradiation lines X with a very small constant pitch along the direction from the inserted extreme end to the rear end of the paper money M, not only colored design areas Y1 and Y3, but also a watermark area Y2 where no design exists are irradiated. Accordingly, if the paper money M is, for example, a thousand-yen note which is now circulating, the paper money M extending from the colored design area Y1 on the extreme end M1 (M2) side to the colored design area Y3 leading to the rear end M2 (M1) through the central watermark area Y2 is irradiated and scanned sequentially as shown in FIG. 2. Furthermore, the irradiation lines X are composed of a plurality (X1 to Xn) of lines with each predetermined interval from the extreme end M1 (M2) to the rear end M2 (M1) of the paper money M. Thus, any of irradiation lines X irradiates positively not only the designed areas Y1 and Y3, but also the watermark area Y2.

The discrimination sensor 19 is not limited to such an arrangement that the light projection area 19a of the sensor is disposed on a front face of the inserted paper money M, while the light reception area 19b is disposed on the reverse face thereof so as to oppose to the light projection area 19a, but an arrangement of a reflection type sensor wherein light is projected and also received on the same side is also applicable. Moreover, such an arrangement that light is irradiated at a constant input angle, and the light reception area 19b is constituted through reflection may be applied. Besides, a plurality of the discrimination sensors 19 may be provided so as to correspond to the respective irradiation lines X.

The paper-like sheet discriminator 1 according to the present invention is controlled by a controller 30 shown in FIG. 3. The controller 30 is provided with the CPU 31 wherein a ROM 32, RAM 33, an insertion detection sensor 14, the discrimination sensor 19, and a drive motor 34 are connected to the CPU 31, respectively.

The CPU 31 performs convey processing, authenticity judgment processing, containment processing, and the other additional calculation processing (arithmetic processing) of a paper money M in accordance with a prescribed program. The ROM 32 has stored previously a processing program, while the RAM 33 converts output signals from the insertion detection sensor 14 and the discrimination sensor 19 to store them as various data.

In the above-described programs, a processing program in the authenticity judgment part C to be a characteristic program of the present invention is programmed based on the following three means in this order. More specifically, they are (1) a pattern detection means wherein infrared light is irradiated on predetermined irradiation lines X along an insertion direction of an inserted paper-like sheet M with a predetermined interval to detect a pattern of amounts of transmitted lights on the predetermined irradiation lines X; (2) an arithmetic processing means wherein the pattern of amounts of transmitted lights obtained by the pattern detection means is compared with a pattern of amounts of transmitted lights of a genuine paper-like sheet MA which has been previously obtained by the pattern detection means to standardize the data, thereby obtaining standard values S at respective irradiation points P of the paper-like sheet MA inserted; and (3) a judgment means wherein the standard values S are compared with the maximum standard value Tₘₐₓ of the genuine paper-like sheet MA which has been previously obtained, and when the number of the standard values S, a value of which is larger than that of the maximum standard value Tₘₐₓ, reaches a predetermined number, then, it is judged that the paper-like sheet M inserted is a counterfeit note. In other words, the pattern detection means converts input signals to store the data converted, and conducts analysis processing with respect to the data. The arithmetic processing means compares the signal data obtained by the pattern detection means with the data which have been already stored in the ROM 32 or the RAM 33, and conducts calculation and the like with respect to these data. The judgment means performs authenticity judgment processing being an ultimate goal of the present invention based on the comparative data and a predetermined threshold value.

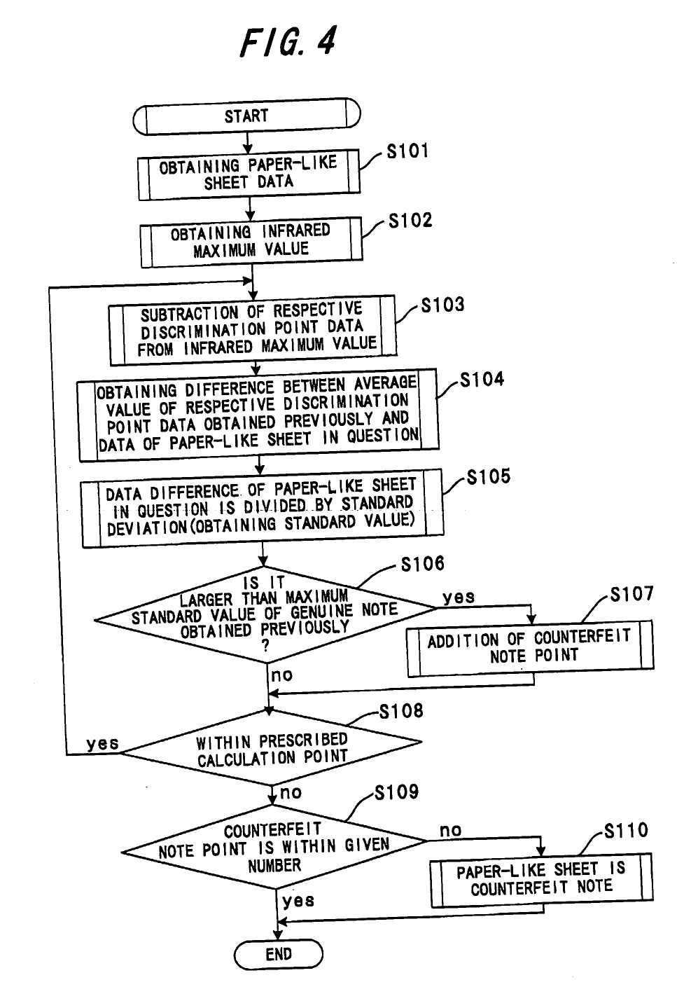

In the following, a routine of the authenticity judgment part C in the paper money discriminator 1 will be described in each step in conjunction with FIG. 4 wherein the inserted paper-like sheet M and the genuine paper-like sheet MA are paper moneys, respectively. Furthermore, it is to be noted that routines in the insertion detection part A and the convey part B are the same as those of the technology disclosed in the above-described approaches (Japanese patent application laid-open Nos. 2003-187291 and 2003-187294), so that the explanation therefor is omitted.

(S101: Obtaining Data)

When an extreme end M1 (M2) of a paper money M inserted reaches the discrimination sensor 19, irradiation of light is started with respect to predetermined irradiation lines X on the inserted paper money M with a constant pitch, and scanning is continued until the irradiation reaches a rear end M2 (M1) of the inserted paper money M. During the scanning, amounts of transmitted light at irradiation points P in respective pitches are obtained from the inserted paper money M as data, and the data thus obtained are output to the CPU 31 as electrical signals. On one hand, such a case where data of amounts of transmitted light are obtained with respect to a number of genuine paper moneys MA at irradiation points P in respective pitches by means of the paper money discriminator 1 is the same as that described above.

(S102: Obtaining Maximum Value of Transmitted Infrared Light)

From this step onward, all the steps relate to processing in the CPU 31. Data of amounts of transmitted light at irradiation points P in respective pitches are compared in every irradiation lines of the genuine paper moneys MA obtained in the step 101, whereby the maximum amount of transmitted infrared light is determined as data.

(S103: Arithmetic Processing I)

An amount of transmitted light at each of the respective irradiation points P is subtracted from the maximum amount of transmitted light obtained in the step S102 to determine a difference.

(S104: Arithmetic Processing II)

A difference between an average value of the amounts of transmitted light at the respective irradiation points P which have been previously obtained with respect to the genuine paper money MA and each data at irradiation points P corresponding to the respective irradiation points in the inserted paper money M is determined.

(S105: Arithmetic Processing III)

In order to standardize each pattern of data at an arbitrary irradiation point P of the inserted paper money M and the genuine paper money MA, a difference between each average value and each data at respective irradiation points P of the inserted paper money M obtained in the step S104 is divided by standard deviation to determine a standard value S.

(S106: Comparison Processing)

The standard value S obtained in the step S105 is compared with the maximum standard value Tₘₐₓ among standard values of the genuine paper money MA.

(S107: Addition Instruction)

When it is judged that the standard value S determined in the step S106 is larger than the maximum standard value Tₘₐₓ of the genuine paper money MA, addition is instructed to be further compared with a standard value S at the subsequent irradiation point P in the inserted paper money M.

(S108: Judgment Processing I)

It is judged whether or not the number of the irradiation points P added in the inserted paper money M compared in the step S107 is less than the number of the irradiation points which have been previously determined. This processing is the one for making possible to realize a comparison by the use of the bottom limit irradiation points P (for example, data on at least one of the irradiation lines X must be checked at the least). As a result, if the number of the irradiation points P added is less than that of the predetermined irradiation points, its process returns to the step 103.

(S109: Judgment Processing II)

If the number of the irradiation points P added is more than that of the predetermined irradiation points in the step S108, it is judged whether or not the number of the irradiation points P on the inserted paper money M exceeds a definite number (threshold value).

(S110: Final Judgment Processing)

When the number of the irradiation points P on the inserted paper money M exceeds the definite number (threshold value) in the step S109, it is judged that the inserted paper money M is a counterfeit note.

There is a case where very few pieces (only a piece in an extreme case) of paper moneys are sufficient substantially for taking data from the genuine paper money MA in the step A101. Such case is, for example, either where appearance of dispersion in the genuine paper money MA can be disregarded substantially perfect with the progress of printing technology, or where such dispersion is very small, so that a standard deviation becomes also small based on the dispersion.

On one hand, when data is not taken by the use of the paper money discriminator 1 from the genuine paper money MA, but the data is taken separately by a similar apparatus, data obtained (data as to one thousand-yen note, or ten thousand-yen note) may be stored previously in the ROM 32 or the RAM 33.

Moreover, although addition processing is continued until a required number is obtained in the addition instruction of the step S107, there are two methods for executing the step S107. Namely, one of them is a method wherein data are simply compared in every irradiation points P, and the other is a method wherein data of added irradiation points P is added to the data before addition, in other words, data are added together (so as to obtain a standard value S1+S2 and to obtain 2×Tₘₐₓ from the maximum standard value Tₘₐₓ, respectively) to compare the data.

According to the latter method, there is a case even when an amount of transmitted light at a certain irradiation point P on the inserted paper money M exceeds remarkably the maximum standard value Tₘₐₓ, it is cancelled by an amount of transmitted light at an irradiation point P prior to the former irradiation point P. An occasion where an amount of transmitted light at a certain irradiation point P exceeds remarkably the maximum standard value Tₘₐₓ is, for example, a case where the irradiation point P is extremely stained. Under the circumstances, there is rather a fear of an erroneous judgment wherein if such extraordinary irradiation points are scattered, then, a paper money in question is judged as a counterfeit note. Accordingly, the latter method is effective for the above-described case where the irradiation point P is extremely stained.

In the present invention as described above, although a transmission type infrared optical sensor is used, it may be replaced, for example, by an ultrasonic sensor. The reason why such replacement may be applied is in that if there are corrugations and roughness on a surface of an inserted paper money M, it is possible to measure variations in a distance from a light source, and to use the results measured as data for the above-described procedure.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

1. A method for discriminating paper-like sheets, comprising:
an authenticity judgment step;
the authenticity judgment step includes:
a pattern detection step for irradiating infrared light on predetermined irradiation lines extending in a paper-like sheet along the direction corresponding to that to be inserted with a predetermined interval to detect amounts of a pattern of transmitted light on the predetermined irradiation lines;
an arithmetic processing step for comparing amounts of the pattern of transmitted light through the paper-like sheet obtained by the pattern detection step with amounts of a pattern of transmitted light through a genuine paper-like sheet which has been previously obtained by means of the pattern detection step to standardize data thereby obtaining standard values at the respective irradiation points of the paper-like sheet inserted; and
a judgment step for comparing the standard values with the maximum standard value of the genuine paper-like sheet which has been previously obtained thereby to judge the paper-like sheet as a counterfeit note in the case when the number of the standard values each of which is larger than the maximum standard value reaches a predetermined number.

2. The method for discriminating paper-like sheets as defined in claim 1, wherein:
the paper-like sheet inserted and the genuine paper-like sheet are the same kind of paper moneys wherein watermark areas and the other design areas are arranged.

3. The method for discriminating paper-like sheets as defined in claim 1, wherein:
the genuine paper-like sheet is two or more pieces.

4. The method for discriminating paper-like sheets as defined in claim 1, wherein:
the standard values are calculated through a division of differences between an average value of amounts of transmitted lights at the respective irradiation points on the predetermined irradiation lines in a genuine paper-like sheet which have been previously obtained and amounts of transmitted light at irradiation points corresponding to respective irradiation points on the predetermined irradiation lines of the paper-like sheet inserted by standard deviations of the amounts of transmitted light at the respective irradiation points in the genuine paper-like sheet.

5. The method for discriminating paper-like sheets as defined in claim 1, wherein:
the maximum standard value is the maximum numerical value among values calculated through a division of differences between an average value of amounts of transmitted lights on respective irradiation points on the predetermined irradiation lines in the genuine paper-like sheet which have been previously obtained and amounts of transmitted lights on respective irradiation points of respective genuine paper-like sheets by standard deviations of amounts of transmitted light at the respective irradiation points.

6. The method for discriminating paper-like sheets as defined in claim 1, wherein:
the pattern detection step detects the pattern of amounts of transmitted light through the inserted paper-like sheet and the genuine paper-like sheet, each having watermark areas and the other design areas.

7. The method for discriminating paper-like sheets as defined in claim 1, wherein:
an instruction for adding the standard value calculated in a paper-like sheet inserted to a standard value at the following irradiation point is issued for a further comparison, when the standard value calculated is judged that it is larger than the maximum standard value in the genuine paper-like sheet.

8. An apparatus for discriminating paper-like sheets, comprising:
an authenticity judgment part;
the authenticity judgment part includes:
a pattern detection means for irradiating infrared light on predetermined irradiation lines extending in a paper-like sheet along the direction corresponding to that to be inserted with a predetermined interval to detect amounts of a pattern of transmitted light on the predetermined irradiation lines;
an arithmetic processing means for comparing amounts of the pattern of transmitted light through the paper-like sheet obtained by the pattern detection means with amounts of a pattern of transmitted light through a genuine paper-like sheet which has been previously obtained by means of the pattern detection means to standardize data thereby obtaining standard values at the respective irradiation points of the paper-like sheet inserted; and
a judgment means for comparing the standard values with the maximum standard value of the genuine paper-like sheet which has been previously obtained thereby to judge the paper-like sheet as a counterfeit note in the case when the number of the standard values each of which is larger than the maximum standard value reaches a predetermined number.

9. The apparatus for discriminating paper-like sheets as defined in claim 8, wherein:
the pattern detection means contains a plurality of light projection areas and a plurality of light reception areas arranged in parallel corresponding to a plurality of irradiation lines, respectively.

10. The apparatus for discriminating paper-like sheets as defined in claim 8, wherein:
the pattern detection means irradiates infrared light based on a pattern of the irradiation points stored in a memory.

11. The apparatus for discriminating paper-like sheets as defined in claim 8, wherein:
the authenticity judgment part is composed of the pattern detection means, arithmetic processing means, and the judgment means.

12. The apparatus for discriminating paper-like sheets as defined in claim 8, wherein:
the discrimination sensor is a reflection type sensor in which infrared light is projected and received on the same side.

13. The apparatus for discriminating paper-like sheets as defined in claim 8, wherein:
the discrimination sensor is constituted in such that infrared light is irradiated at a given input angle, and a light reception area is disposed through reflection.
